(19) United States
(12) Patent Application Publication
(10) Pub. No.: US 2021/0212340 A1
(43) Pub. Date: Jul. 15, 2021

(54) PET TREAT AND METHODS OF MAKING SAME

(71) Applicant: Transhumance Holding Company, Inc., Sacramento, CA (US)

(72) Inventors: Bernard Knight, Hospers, IA (US); Kenneth Wilks, Citrus Heights, CA (US); Gary Pfeiffer, Danville, CA (US)

(21) Appl. No.: 16/738,848

(22) Filed: Jan. 9, 2020

(51) Int. Cl. A23K 10/20; A23K 40/00; A23K 30/00; A23K 50/42

(52) U.S. Cl. CPC A23K 10/20; A23K 50/42; A23K 30/00; A23K 40/00

(57) ABSTRACT

The disclosure generally relates to a pet treat comprising animal pizzle, the pet treat having a pet treat length, a width, and a thickness and the pet treat is generally planar along at least about 90% of the pet treat length. The disclosure also relates to methods for making such pet treats.

### BACKGROUND OF THE INVENTION

Treats are a great way to reward a dog for being well behaved, for reinforcing a dog while training, or just to express how much one likes his or her pet. Dogs appear to enjoy having variety textures and flavors. “Bully sticks,” for example, are a single-ingredient dog chew that is made from high-protein beef muscle, specifically, the pizzle of a bull. Dogs of any breed, size or age can take advantage of their many great benefits while satisfying their natural instinct to chew. Bully sticks come in many different shapes and forms, including a straight bully stick or a bully stick pretzel that is ideal for a dog that is a light chewer; and braided bully sticks, knotted bully stick bones, curly bully sticks, and bully stick rings for more aggressive chewers. But because products like bully sticks use the entire pizzle, it does not lend itself to any form other than the aforementioned product formats (e.g., sticks and braided products).

### SUMMARY

The disclosure provides, among other things, a substantially flat jerky-like pet treat format that has not been accessible from pizzle, including bull pizzle. This format has the benefit of having the consistency of jerky while being sourced from what could be considered a pizzle waste-stream. Accordingly, the jerky-like pet treat format described herein is not only economical to make, but is well-liked by pet owners and pets alike, due to its texture.

### BRIEF DESCRIPTION OF THE FIGURES

The drawings illustrate generally, by way of example, but not by way of limitation, various embodiments discussed in the present document.

FIG. 1 is schematic of a pet treat according to the disclosure.

FIG. 2A is side view of a portion of the pet treat shown in FIG. 1 where the pet treat has irregular texture on at least a portion of a first major surface and at least a portion of a second major surface.

FIG. 2B is side view of a portion of the pet treat shown in FIG. 1 where the pet treat has a regular texture on at least a portion of a first major surface and at least a portion of a second major surface.

FIG. 3 is side view of a portion of a frozen pizzle slice.

### DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

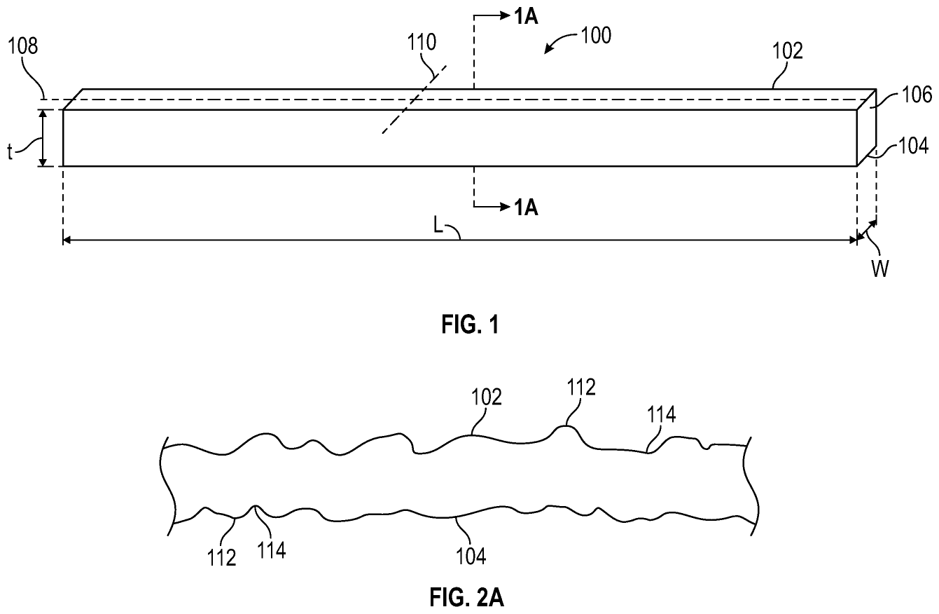

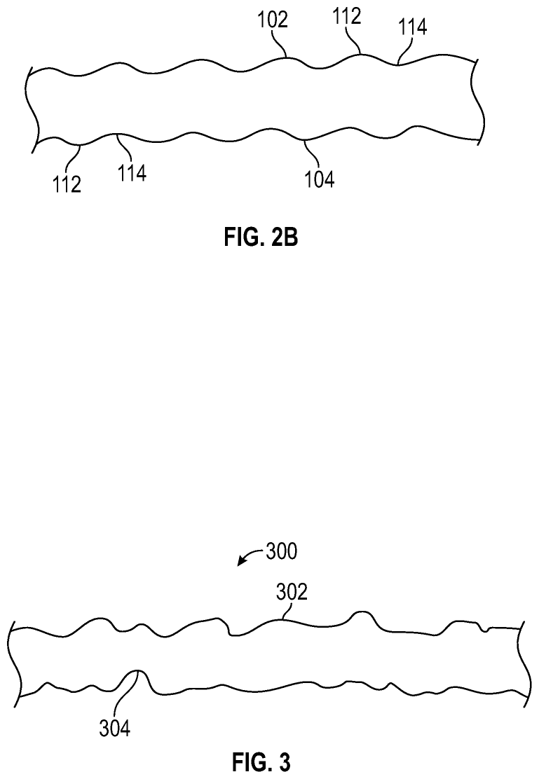

Making reference to FIG. 1, the disclosure generally relates to a pet treat 100 having a length (L), a width (W), and a thickness (t). Further, the pet treat 100 has a first major surface 102 and the second major surface 104 opposite the first major surface 102. A minor surface 106 connects the first major surface 102 and the second major surface 104. Although the pet treat shown in FIG. 1 is generally planar along at least about 90%, at least about 92%, at least about 95%, at least about 97%, at least about 99%, about 100%, about 90% to about 100%, about 95% to about 99% or about 100% of the pet treat length (L), they can have a texture in the form of, among other forms, undulations and irregularities along the longitudinal axis 108, as well as undulations or irregularities along the orthogonal axis 110. FIG. 2A is a cross section along line 1A that shows an example of the texture that the pet treat can have along the longitudinal axis 108. The portion of pet treat 100 shown in FIG. 2A has first major surface 102 and second major surface 104 and undulations/irregularities having “peaks” 112 and “valleys” 114 on the first and second major surfaces. Although the texture shown in FIG. 2A shows an irregular texture to first major surface 102 and second major surface 104, the texture need not be irregular. The texture can also be regular as shown in FIG. 2B, with the undulations having “peaks” 112 and “valleys” 114 at more regular intervals/frequency.

The pet treat 100 shown in FIG. 1 in the form of a strip. As such, the pet treat can have a pet treat length (L) and width (W) ratio that is from about 1:1 to about 10:1 (e.g., about 2:1, about 3:1, about 4:1, about 5:1, about 6:1, or about 8:1). Alternatively or in addition, the pet treat 100 can have a pet treat width (W) and thickness (t) ratio that is from about 10:1 to about 4:1 (e.g., about 8:1, about 6:1 or about 5:1). But the pet treats contemplated herein can have any shape so long as the pet treat is generally planar. For example, the pet treat 100 will not be in the form of a cylinder, such as in a bully stick. Thus, for example, the pet treat 100 can be in the form of not only strips, but also squares, triangles, circles, animal shapes, etc. In some instances, any of the foregoing shapes can result from punching or otherwise cutting of a larger sheet.

The pet treat 100 can be made of animal pizzle. The type of animal pizzle used to make the pet treat is not limiting. Thus, for example, the animal pizzle can be that of an animal from the Bovidae family of animals, which is the biological family of cloven-hoofed, ruminant mammals including bison, African buffalo, water buffalo, antelopes, wildebeest, impala, gazelles, sheep, goats, muskoxen, and domestic cattle. As used herein, the term “pizzle” generally refers to a penis of a non-human animal and includes muscle, fat, sinew, collagen, bone, cartilage, and other pizzle parts. In some instances, however, the pet treat is substantially free of at least one of bone and cartilage.

The percentages by weight provided in the disclosure are determined at below 0.60 water activity unless otherwise noted.

The pet treat 100 has a moisture content of less than about 12%, less than about 10%, less than about 8%, less than about 6%, less than about 4%, less than about 2%, about 1% to about 12%, about 0.05% to about 5%, about 1% to about 3% or about 2% to about 5% moisture by weight.

Alternatively or in addition, the pet treat 100 can have a protein content of at least about 60%, at least about 65% at least about 70%, at least about 75%, at least about 80%, at least about 85%, at least about 90%, at least about 95%, about 60% to about 80%, about 70% to about 85%, about 75% to about 85% or about 75% to about 90% protein by weight.

Alternatively or in addition, the pet treat 100 can have a fat content of at least about 0.05%, at least about 0.5%, at least about 1%, at least about 2%, at least about 5%, about 0.05% to about 2%, about 1% to about 5%, about 1% to about 3% or about 2% to about 5% fat by weight.

Alternatively or in addition, the pet treat 100 can have a fiber content of less than about 5%, less than about 3%, less than about 2%, less than about 1%, about 0.05% to about 2%, about 1% to about 5%, about 1% to about 3% or about 0.05% to about 1% fiber by weight.

The pet treat 100 can have any suitable color, which can be determined visually. For example, the pet treat 100 can have the appearance of beef jerky and can have a pink to dark red to brown color, with slight variations (lighter or darker) being acceptable. Although blue or black hues may not be as desirable as pink to dark red colors, blue and black hues may still be acceptable in some instances.

Although it is preferable that the pet treat 100 be substantially free of additives or preservatives, pet treats comprising at least one of additives and preservatives is not outside of the purview of the disclosure. Further, the pet treat 100 can comprise additives that are commonly used in the production of products meant for consumption by animals, including dogs. For example, the pet treat 100 can comprise additives for at least one of coloring, palatability, and nutritional purposes. Such additives can include, for example, colorants, vitamins, minerals, fiber (e.g., cellulose, beet pulp, peanut hulls, and soy fiber), probiotics, prebiotics, fillers, palatability enhancers, binding agents, flavors, stabilizers, emulsifiers, sweeteners, salts, and the like known to skilled artisans.

If the pet treat 100 comprises additives such as vitamins and minerals, those additives can be included in amounts required to avoid deficiency and maintain health. These amounts are readily available in the art. The National Research Council (NRC) provides recommended amounts of such ingredients for farm animals. See, e.g., Nutrient Requirements of Swine (10th Rev. Ed., Nat'l Academy Press, Wash. D.C., 1998), Nutrient Requirements of Poultry (9th Rev. Ed., Nat'l Academy Press, Wash. D.C., 1994), Nutrient Requirements of Horses (5th Rev. Ed., Nat'l Academy Press, Wash. D.C., 1989), etc. The American Feed Control Officials (AAFCO) provides recommended amounts of such ingredients for dogs and cats. See American Feed Control Officials, Inc., Official publication, pages 126 140 (2003).

Additives include sources of fiber ingredients, mineral ingredients, vitamin ingredients, polyphenols ingredients, amino acid ingredients, carotenoid ingredients, antioxidant ingredients, fatty acid ingredients, glucose mimetic ingredients, probiotic ingredients, prebiotic ingredients, and still other ingredients.

Sources of fiber ingredients can include fructooligosacchalides (FOS), beet pulp, mannanoligosacchalides (MOS), oat fiber, citrus pulp, carboxymethylcellulose (CMC), guar gum, gum arabic, apple pomace, citrus fiber, fiber extracts, fiber delivatives, dried beet fiber (sugar removed), cellulose, a-cellulose, galactooligosacchalides, xylooligosaccharides, and oligo derivatives from starch, inulin, psyllium, pectins, citrus pectin, guar gum, xanthan gum, alginates, gum arabic, gum talha, beta-glucans, chitins, lignin, celluloses, non-starch polysacchalides, carrageenan, reduced starch, soy oligosaccharides, trehalose, raffinose, stachyose, lactulose, polydextrose, oligodextran, gentioligosacchalide, pectic oligosacchalide, and/or hemicellulose.

Sources of mineral ingredients can include sodium selenite, monosodium phosphate, calcium carbonate, potassium chloride, ferrous sulfate, zinc oxide, manganese sulfate, copper sulfate, manganous oxide, potassium iodide, and/or cobalt carbonate.

Sources of vitamin ingredients can include choline chloride, vitamin E supplement, ascorbic acid, vitamin A acetate, calcium pantothenate, pantothenic acid, biotin, thiamine mononitrate (source of vitamin B1), vitamin B12 supplement, niacin, riboflavin supplement (source of vitamin B2), inositol, pyridoxine hydrochloride (source of vitamin B6), vitamin D3 supplement, folic acid, vitamin C, and/or ascorbic acid. Sources of polyphenols ingredients can include tea extract, rosemary extract, rosemarinic acid, coffee extract, caffeic acid, turmeric extract, blueberry extract, grape extract, grapeseed extract, and/or soy extract. Sources of amino acid ingredients can include 1-Tryptophan, Taurine, Histidine, Carnosine, Alanine, Cysteine, Arginine, Methionine, Tryptophan, Lysine, Asparagine, Aspartic acid, Phenylalanine, Valine, Threonine, Isoleucine, Histidine, Leucine, Glycine, Glutamine, Taurine, Tyrosine, Homocysteine, Ornithine, Citruline, Glutamic acid, Proline, and/or Serine. Sources of carotenoid ingredients can include lutein, astaxanthin, zeaxanthin, bixin, lycopene, and/or beta-carotene. Sources of antioxidant ingredients can include tocopherols (vitamin E), vitamin C, vitamin A, plant-derived materials, carotenoids (described above), selenium, and/or CoQ1O (Co-enzyme Q1O).

Sources of fatty acid ingredients can include arachidonic acid, alpha-linoleic acid, gamma linolenic acid, linoleic acid, eicosapentanoic acid (EPA), docosahexanoic acid (DHA), and/or fish oils as a source of EPA and/or DHA. Sources of glucose mimetic ingredients can include glucose anti-metabolites including 2-deoxy-D-glucose, 5-thio-D-glucose, 3-0-methylglucose, anhydrosugars including 1,5-anhydro-D-glucitol, 2,5-anhydro-D-glucitol, and 2,5-anhydro-D-mannitol, mannoheptulose, and/or avocado extract comprising mannoheptulose.

Still other ingredients can include beef broth, brewers dried yeast, egg, egg product, flax meal, DL methionine, amino acids, leucine, lysine, arginine, cysteine, cystine, aspartic acid, polyphosphates such as sodium hexametaphosphate (SHMP), sodium pyrophosphate, sodium tripolyphosphate; zinc chloride, copper gluconate, stannous chloride, stannous fluoride, sodium fluoride, triclosan, glucosamine hydrochloride, chondroitin sulfate, green lipped mussel, blue lipped mussel, methyl sulfonyl methane (MSM), boron, boric acid, phytoestrogens, phytoandrogens, genistein, diadzein, L-carnitine, chromium picolinate, chromium tripicolinate, chromium nicotinate, acid/base modifiers, potassium citrate, potassium chloride, calcium carbonate, calcium chloride, sodium bisulfate; eucalyptus, lavender, peppermint, plasticizers, colorants, flavorants, sweeteners, buffering agents, slip aids, carriers, pH adjusting agents, natural ingredients, stabilizers, biological additives such as enzymes (including proteases and lipases), chemical additives, coolants, chelants, denaturants, drug astringents, emulsifiers, external analgesics, fragrance compounds, humectants, opacifying agents (such as zinc oxide and titanium dioxide), anti-foaming agents (such as silicone), preservatives (such as butylated hydroxytoluene (BHT) and butylated hydroxyanisole (BHA), propyl gallate, benzalkonium chlolide, EDTA, benzyl alcohol, potassium sorbate, parabens and mixtures thereof), reducing agents, solvents, hydrotropes, solubilizing agents, suspending agents (non-surfactant), solvents, viscosity increasing agents (aqueous and non-aqueous), sequestrants, and/or keratolytics.

The probiotic ingredient or component can comprise one or more bacterial probiotic microorganisms suitable for pet consumption and effective for improving the microbial balance in the pet gastrointestinal tract or for other benefits, such as disease or condition relief or prophylaxis, to the pet. Various Probiotic microorganisms are known in the art. See, for example, WO 03/075676, and U.S. Published Application No. US 2006/0228448A1, both of which are incorporated by reference as if fully set forth herein.

The probiotic component, when present, can be selected from bacteria, yeast or microorganism of the genera Bacillus, Bacteroides, Bifidobacterium, Enterococcus (e.g., Enterococcus faecium DSM 10663 and Enterococcus faecium SF68), Lactobacillus, Leuconostroc, Saccharomyces, Candida, Streptococcus, and mixtures of any thereof. The probiotic can be selected from the genera Bifidobacterium, Lactobacillus, and combinations thereof. Those of the genera Bacillus may form spores. Non-limiting examples of lactic acid bacteria suitable for use herein include strains of Streptococcus lactis, Streptococcus cremoris, Streptococcus diacetylactis, Streptococcus thermophilus, Lactobacillus bulgaricus, Lactobacillus acidophilus (e.g., Lactobacillus acidophilus strain DSM 13241), Lactobacillus helveticus, Lactobacillus bifidus, Lactobacillus casei, Lactobacillus lactis, Lactobacillus plantarum, Lactobacillus rhamnosus, Lactobacillus delbrukii, Lactobacillus thermophilus, Lactobacillus fermentii, Lactobacillus salvarius, Lactobacillus reuteri, Bifidobacterium longum, Bifidobacterium infantis, Bifidobacterium bifidum, Bifidobacterium animalis, Bifidobacterium pseudolongum, and Pediococcus cerevisiae, or mixtures of any thereof. The pet treats described herein can have a probiotic-enriched coating. When present, such a coating can comprise the bacterial strain Bfidobacterium animalis AHC7 NCIMB 41199.

The probiotic ingredient can include one or more microorganisms identified in U. S. Published Application Nos. US 2005/0152884A1, US 2005/0158294A1, US 2005/0158293A1, US 2005/0175598A1, US 2006/0269534A1, and US 2006/0270020A1 and in PCT International Publication No. WO 2005/060707A2, all of which are incorporated by reference as if fully set forth herein.

Examples of emulsifiers and/or thickening agents include gelatin, cellulose ethers, starch, starch esters, starch ethers, and modified starches. Specific amounts will depend on a variety of factors. The amount of such additives in a composition typically is up to about 5% by weight.

“Prebiotic” means food substances that promote the growth of probiotics in the intestines. They are not broken down in the stomach and/or upper intestine or absorbed in the GI tract of the person ingesting them, but they are fermented by the gastrointestinal microflora and/or by probiotics. Prebiotics are for example defined by Glenn R. Gibson and Marcel B. Roberfroid, Dietary Modulation of the Human Colonic Microbiota: Introducing the Concept of Prebiotics, J. Nutr. 1995 125: 1401-1412.

The prebiotics that can be used in accordance with the disclosure are not particularly limited and include all food substances that promote the growth of probiotics in the intestines. Prebiotics include, for example, oligosaccharides, optionally containing fructose, galactose, mannose; dietary fibers, in particular soluble fibers, soy fibers; inulin; or mixtures thereof. Specific prebiotics include inulin, fructo-oligosaccharides (FOS), galacto-oligosaccharides (IOS), isomalto-oligosaccharides, xylo-oligosaccharides, oligosaccharides of soy, glycosylsucrose (GS), lactosucrose (LS), lactulose (LA), palatinose-oligosaccharides (PAO), gums and/or hydrolysates thereof, pectins and/or hydrolysates thereof.

The pet treat 100 can be substantially free of curing agents (e.g., nitrates and nitrites, such as sodium nitrite and potassium nitrate), seasonings, denaturants, green-based colors, and other toxic materials, including plastics, pesticides, organic solvents (e.g., kerosene) and residues thereof, cleaning agents and residues thereof, and unauthorized chemicals (e.g., chemicals that have been found to have a deleterious effect on animal well-being and health). In addition, the pet treat 100 can be substantially free of chemical additives, coolants, chelants, denaturants, drug astringents, emulsifiers, external analgesics, fragrance compounds, humectants, opacifying agents (such as zinc oxide and titanium dioxide), anti-foaming agents (such as silicone), preservatives (such as butylated hydroxytoluene (BHT) and butylated hydroxyanisole (BHA), propyl gallate, benzalkonium chlolide, EDTA, benzyl alcohol, potassium sorbate, parabens and mixtures thereof), reducing agents, solvents, hydrotropes, solubilizing agents, suspending agents (non-surfactant), solvents, viscosity increasing agents (aqueous and non-aqueous), sequestrants, and/or keratolytics. In addition, the the pet treat 100 can be substantially free of foreign materials, including glass, paper, plastic, rubber, garbage, wood, metal, and stone.

The pet treat 100 can contain at least about 85 wt. %, at least 90 wt. %, at least 95 wt. %, at least 98 wt. %, at least 99 wt. %, from about 85 wt. % to about 100 wt. %, about 90 wt. % to about 100 wt. %, about 95 wt. % to about 99 wt. % or about 100 wt. % animal pizzle.

The disclosure also relates to methods of making pet treat 100. One method for making pet treat 100 includes cutting a frozen block (e.g., a frozen nude block cut with a bandsaw or any suitable cutting implement) comprising substantially frozen pizzle to give a first plurality of generally planar, substantially frozen pizzle slices; locating the first plurality of substantially frozen, generally planar pizzle slices substantially flat on screens (e.g., metal wire screens) comprising a lining material (e.g., a lining material that is a non-stick lining material, such as parchment paper); freezing the first plurality of substantially frozen, generally planar pizzle slices to give a second plurality of substantially frozen, generally planar pizzle slices; and heating the second plurality of substantially frozen, generally planar pizzle slices at a temperature and for a time sufficient to cook the pizzle and give solid, generally planar, cooked pizzle slices that constitute pet treat 100.

The first and second substantially frozen pizzle slices, just like the pet treat 100, have a length (L), a width (W), and a thickness (t). Making reference to FIG. 3, frozen pizzle slices 300 (only a portion shown) have a first major surface 302 and the second major surface 304 opposite the first major surface 302. A minor surface (not shown) connects the first major surface 302 and the second major surface 304. Although the first and second substantially frozen pizzle slices shown in FIG. 3 are generally planar along at least about 90%, at least about 92%, at least about 95%, at least about 97%, at least about 99%, about 100%, about 90% to about 100%, about 95% to about 99% or about 100% of the pet treat length (L), they, like pet treat 100, can have a texture in the form of, among other forms, undulations or irregularities (not shown) along the longitudinal axis 208, as well as undulations or irregularities (not shown) along the orthogonal axis 210.

The first and second substantially frozen pizzle slices 300 shown in FIG. 3 in the form of a strip. As such, the first and second substantially frozen pizzle slices can have first and second substantially frozen pizzle slices length (L) and width (W) ratio that is from about 1:1 to about 10:1 (e.g., about 2:1, about 3:1, about 4:1, about 5:1, about 6:1, or about 8:1). In addition, the first and second substantially frozen pizzle slices 300 can have a first and second substantially frozen pizzle slices width (W) and thickness (t) ratio that is from about 10:1 to about 4:1 (e.g., about 8:1, about 6:1 or about 5:1). But the first and second substantially frozen pizzle slices contemplated herein can have any shape so long as the first and second substantially frozen pizzle slices are substantially planar. For example, the first and second substantially frozen pizzle slices 300 can be in the form of not only strips, but also squares, triangles, circles, animal shapes, etc. In some instances, any of the foregoing shapes can result from punching or otherwise cutting of a larger sheet.

The heating of the second plurality of substantially frozen pizzle slices to ultimately give solid, generally planar cooked pizzle slices can include heating at several different temperatures and for several different time periods. For example, heating of the second plurality of substantially frozen pizzle slices to ultimately give solid, generally planar cooked pizzle slices can be heated using a temperature and time program. Further, the heating of the second plurality of substantially frozen pizzle slices to ultimately give solid, generally planar cooked pizzle slices can include using a temperature and time program that is sufficient to achieve a critical control point.

Those of skill in the art will recognize that each food product must be cooked to an elevated internal temperature which is at least high enough to meet food safety requirements. Poultry, for instance, must be thoroughly cooked to at least 160° F. according to Hazard Analysis Critical Control Point (HACCP) requirements, meaning that each and every part of the poultry must reach or exceed that temperature. With regard to the heating of the second plurality of substantially frozen pizzle slices to ultimately give solid, generally planar cooked pizzle slices, the critical control point includes, but is not limited to, heating the second plurality of substantially frozen pizzle slices to an internal temperature of one or more of the pizzle slices of about 160° F. held for at least 20 minutes.

A temperature and time program can also include at least one of the following: about 15 minutes at an oven temperature set to about 145° F. with oven damper open; about 60 minutes at an oven temperature set to about 145° F. and a wet bulb temperature of about 135° F., and oven damper closed;

60 minutes at an over temperature set to about 155° F. with oven damper open;
about 120 minutes at an oven temperature set to about 160° F. with oven damper open;
about 120 minutes at an oven temperature set to about 165° F. with oven damper open;
about 360 minutes at an oven temperature set to about 175° F. with oven damper open; and
about 600 minutes at an oven temperature set to about 145° F. with oven damper open.

A temperature and time program can include all of the following:

about 15 minutes at an oven temperature set to about 145° F. with a damper open;
about 60 minutes at an oven temperature set to about 145° F. and a wet bulb temperature of about 135° F., and oven damper closed;
60 minutes at an over temperature set to about 155° F. with oven damper open;
about 120 minutes at an oven temperature set to about 160° F. with oven damper open;
about 120 minutes at an oven temperature set to about 165° F. with oven damper open;
about 360 minutes at an oven temperature set to about 175° F. with oven damper open; and
about 600 minutes at an oven temperature set to about 145° F. with oven damper open.

A temperature and time program can include all of the following, each performed in series:

about 15 minutes at an oven temperature set to about 145° F. with a damper open;
about 60 minutes at an oven temperature set to about 145° F. and a wet bulb temperature of about 135° F., and oven damper closed;
60 minutes at an over temperature set to about 155° F. with oven damper open;
about 120 minutes at an oven temperature set to about 160° F. with oven damper open;
about 120 minutes at an oven temperature set to about 165° F. with oven damper open;
about 360 minutes at an oven temperature set to about 175° F. with oven damper open; and
about 600 minutes at an oven temperature set to about 145° F. with oven damper open.

Following the heating, the solid, generally planar cooked pizzle slices can be cooled, e.g., to about ambient temperature, such as to about 75° C. Once cooled, the solid, generally planar cooked pizzle slices can be processed in any suitable fashion to give pet treat 100. In some instances, the solid, generally planar cooked pizzle slices are not processed further, such that the solid, generally planar cooked pizzle slices and pet treat 100 are one and the same. In other instances, however, the solid, generally planar cooked pizzle slices are processed further by performing, e.g., a drying step, a cutting step or a coating step (e.g., a flavor coating).

The pet treat 100 can then be packaged in any suitable fashion. For example, individual pet treats can be stacked and arranged into a box. In other instances, two or more pet treats can be placed in a paper or plastic container and the container is subsequently sealed. In some instances, a plastic container including a plurality of pet treats can be vacuum packed. In other instances, each individual pet treat 100 can be packaged individually by placing each individual pet treat 100 in a paper or plastic container or vacuum packed in a plastic container. In still other instances, each individual pet treat 100 can be shrink-wrapped using a suitable plastic material. Alternatively or in addition, a plurality of pet treats can be shrink-wrapped using a suitable plastic material.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

### Examples

The present invention can be better understood by reference to the following examples which are offered by way of illustration. The present invention is not limited to the examples given herein.

Frozen raw beef pizzle (bulk; approximately 7,500 to 40,000 lbs.) is separated into several containers, each container having about 800 lbs. of frozen raw pizzle. Water is added to each tote to cover the frozen raw pizzle. The totes are then placed in a cooler at a temperature of approximately 35° F. The frozen raw pizzle is allowed to thaw for approximately a week.

The thawed raw pizzle is moved to a different cooler and the water is drained. Once the water is drained, the thawed raw pizzle is trimmed, e.g., on a trimming table, to remove at least excess fat, excess sinew, and the tip of the pizzle. The trimmed pizzle is placed in totes, this time approximately 25 lbs. to each tote. The totes are arranged on pallets and the pallets are placed in a freezer for about a week.

After about a week in the freezer, the material that is in each tote is cut in a cold room (temperature from about 35° F. to about 45° F.) into several strips. The material is cut while fronzen with a band saw to a thickness ranging from 0.25 inches to about 0.5 inches, end-to-end; a width of about 2.5 inches; and a length of about 12 inches. The strips, which have the approximate dimensions of a strip of bacon, are placed on wire screens lined with parchment paper.

The wire screens (e.g., 42″×40″ stainless steel screens) containing the strips are placed in a freezer and are kept in a freezer until all product is cut and placed on wire screens.

The strips are then transferred to an ovens (e.g., four Truck Friedrich Oven (Gas) and two Truck Koch Oven (Electric)) where the strips are heated as follows: 145° F. for 15 minutes with damper open; 145° F. for 60 minutes, wet bulb 135° F., with damper closed such that moisture condenses and reaches 135° F.; 155° F. for 60 minutes with damper open; 160° F. for 120 minutes with damper open; 165° F. for 120 minutes with damper open; 175° F. for 360 minutes with damper open; and 145° F. for 600 minutes with damper open.

Although modifications could be made to this process, the process described in this example makes for an even cook; reduces the odor of the resulting pet treat; and provides an effective critical control point where each strip reaches an internal temperature of about 160° F. and that internal temperature is held for 20 minutes or more so as to control lethality by reducing or eliminating E. Coli and Salmonella from the pet treat.

After cooking, the strips are cooled to ambient temperature in a staging area. The cooled strips are then removed from the screens and transferred onto work table and run through a sealer that individually packages the strips. The resulting packaged pet treat is unique in that it has a resemblance to turkey bacon or beef jerky form.

What is claimed is:

1. A pet treat comprising:
animal pizzle;
wherein the pet treat has a length, a width, and a thickness and the pet treat is generally planar along at least about 90% of the pet treat length.

2. The pet treat of claim 1, wherein the pet treat has a first major surface and the second major surface opposite the first major surface and a minor surface connecting the first major surface and the second major surface and the pet treat has a texture on at least one of the first major surface and the second major surface.

3. The pet treat of claim 1, wherein the pet treat is in the form of a strip.

4. The pet treat of claim 1, wherein the pet treat has a pet treat length and width ratio that is from about 1:1 to about 10:1.

5. The pet treat of claim 4, wherein the pet treat has a pet treat width and thickness ratio that is from about 10:1 to about 4:1.

6. The pet treat of claim 1, wherein the animal pizzle is from the Bovidae family of animals.

7. The pet treat of claim 1, wherein the animal pizzle is from domestic cattle.

8. The pet treat of claim 1, wherein the animal pizzle comprises muscle, fat, sinew, collagen, bone, cartilage, and other pizzle parts.

9. The pet treat of claim 1, wherein the animal pizzle is substantially free of at least one of bone and cartilage.

10. The pet treat of claim 1, wherein the pet treat has at least one of a moisture content of less than about 12%; a protein content of at least about 60%; a fat content of at least about 0.05%; and a fiber content of less than about 5%.

11. The pet treat of claim 1, wherein the pet treat has a moisture content of less than about 12%; a protein content of at least about 60%; a fat content of at least about 0.05%; and a fiber content of less than about 5%.

12. The pet treat of claim 1, wherein the pet treat is substantially free of additives or preservatives.

13. The pet treat of claim 1, wherein the pet treat is substantially free of curing agents.

14. The pet treat of claim 1, wherein the pet treat comprises at least one of additives and preservatives.

15. The pet treat of claim 14, wherein the pet treat comprises at least one of colorants, vitamins, minerals, fiber, probiotics, prebiotics, fillers, palatability enhancers, binding agents, flavors, stabilizers, emulsifiers, sweeteners, and salts.

16. The pet treat of claim 14, wherein the pet treat comprises at least one of mineral ingredients, polyphenol ingredients, amino acid ingredients, carotenoid ingredients, antioxidant ingredients, fatty acid ingredients, and glucose mimetic ingredients.

17. The pet treat of claim 1, wherein wherein the pet treat comprises at least about 85 wt. % animal pizzle.

18. The pet treat of claim 1, wherein the pet treat does not comprise blue or black hues.

19. The pet treat of claim 1, wherein the pet treat has a brown color.

20. A method of making the pet treat of claim 1, the method comprising:
cutting a frozen block comprising substantially frozen pizzle to give a first plurality of generally planar, substantially frozen pizzle slices;
locating the first plurality of substantially frozen, generally planar pizzle slices substantially flat on screens comprising a lining material;
freezing the first plurality of substantially frozen, generally planar pizzle slices to give a second plurality of substantially frozen, generally planar pizzle slices; and
heating the second plurality of substantially frozen, generally planar pizzle slices at a temperature and for a time sufficient to cook the pizzle and give solid, generally planar, cooked pizzle slices.

21. The method of claim 20, wherein the temperature and time is sufficient to achieve a critical control point.

22. The method of claim 21, wherein the critical control point comprises an internal temperature of one or more of the cooking second plurality of substantially frozen, generally planar pizzle slices of about 160° F. held for at least 20 minutes.

23. The method of claim 20, wherein the temperature and time comprises heating, in sequence:
about 15 minutes at an oven temperature set to about 145° F. and oven damper open;
about 60 minutes at an oven temperature set to about 145° F. and a wet bulb temperature of about 135° F., and oven damper closed;
60 minutes at an over temperature set to about 155° F. with oven damper open;
about 120 minutes at an oven temperature set to about 160° F. with oven damper open;
about 120 minutes at an oven temperature set to about 165° F. with oven damper open;
about 360 minutes at an oven temperature set to about 175° F. with oven damper open; and
about 600 minutes at an oven temperature set to about 145° F. with oven damper open.

24. The method of claim 20, wherein the screens are metal wire screens.

25. The method of claim 20, wherein the lining material is a non-stick lining material.

26. The method of claim 20, wherein the lining material is parchment paper.

27. The method of claim 20, further comprising cooling the cooked pizzle slices.

28. The method of claim 27, wherein the cooked pizzle slices are cooled to ambient temperature.

29. The method of claim 20, further comprising packaging the cooked pizzle slices.
